(19) United States
(12) Patent Application Publication
(10) Pub. No.: US 2016/0091121 A1
(43) Pub. Date: Mar. 31, 2016

(54) LOOP HANGER

(71) Applicant: Cambridge Executive Limited, Cambridge (GB)

(72) Inventor: Josh MACKIE, Norfolk (GB)

(21) Appl. No.: 14/864,189

(22) Filed: Sep. 24, 2015

(30) Foreign Application Priority Data
Sep. 25, 2014 (GB) 1416910.6
Jul. 16, 2015 (GB) 1512419.1

(51) Int. Cl. F16L 3/137; F16L 3/12

(52) U.S. Cl. CPC F16L 3/137; F16L 3/1218

(57) ABSTRACT

A method of bracing cabling and a kit for said method. The kit comprises a strap arranged to be supported at one end by a fastener having a head and optionally also having a collar. The other end of the strap, which is made from a resiliently deformable material, can be passed around the cable and over the protruding head of the fastener to form a loop hanger.

### BACKGROUND

The present invention relates to a strap suitable for providing the function of a hanger. It was conceived for the purpose of supporting electric and communication cable; however, the invention may be used to brace other items.

Building regulations require that cabling installed during the construction of new houses requires bracing to reduce the stress placed on the cable and electrical joints. The common practice is to tie bundles of laid cable together at intervals using ties formed from cut-offs of spare cable, nailing each tie to the surface along which the cable is run. Where the cables are run through a ceiling cavity, they are typically braced to the ceiling joists.

A problem with ties formed using the traditional method is that they are not designed to be undone once tied. This makes the process of subsequently adding a run of further cable time consuming and wasteful as the existing ties having to be cut and fresh ties used.

US2005/011028 discloses a binding device having a series of holes at a first end and a hole at a second end. FIG. 8 shows how the binding device is formed as a loop and held together by an integrally formed stud and pin. The pin passes into the loop towards the object being supported. The binding device is not intended to be mounted to a support and no means is provided for that purpose.

An elongated strap disclosed in US2003088948 uses a tooth and buckle type mechanism to form the loop. This allows the loop to be re-opened but is quite fiddly and so relatively time consuming. The strap comprises a handle and boss about which the strap can be mounted to a support.

U.S. Pat. No. 6,386,489 discloses a cable hanger having a flexible strap with a block at a first end for mounting the strap to a support. To form the loop, the second end of the strap is brought to and slid passed the block so as to engage with a lip that protrudes away from the block. The use of a block ensures that the fastener used to secure the hanger to a support does not protrude and so obstruct the second end from engaging with the lip.

### BRIEF SUMMARY

According to a first aspect of the invention there is provided a method of bracing a length of cable comprising: fastening a strap at or about its first end to a support by driving a fastener passed through the strap into the support leaving an end of the fastener proud of the strap; and passing a second end of the strap around the cable and over the proud end of the fastener to form a loop.

Various embodiments of the invention enable one or more lengths of cable to be quickly braced to a support.

It is preferred that the second end is releasably attached to the fastener so that a further length of cable can be run after the cable is braced, whereupon the strap can be again passed around the cable and over the fastener to form a loop. To achieve this, it is preferred that the strap is comprised from a resiliently deformable material.

In a preferred embodiment, the fastener comprises a shaft, a head and a collar spaced from the head; and the method comprises driving the fastener into the support to retain the strap between the support and the collar leaving the head proud of the strap; and passing the second end of the strap over the head of the fastener.

This speeds up the bracing process as the installer simply drives the fastener into the support until the strap is tightly sandwiched between the collar and the support, automatically ensuring that a portion of the fastener protrudes from the strap. This removes the need for the installer to concentrate to ensure the fastener is not driven too far into the support.

It is further preferred that the second end is passed over the fastener so as to sit between the head and collar of the fastener. This allows the second end to be removed from the fastener, when it is wished to add further cables, without interfering with the fixing of the first end of the strap to the support.

According to a second aspect of the invention there is provided a strap suitable for use as a looped support, the strap having a first aperture at or towards a first end through which, when in use, a fastener passes to retain the strap to a support; the strap also comprising a wider portion at or towards a second end of the strap; a further aperture defined in the wider portion for retaining the second end of the strap, when looped, over the fastener; and wherein a portion of the strap that defines the first aperture is comprised from a sheet-like material.

To aid removal of the second end of the strap from the fastener it is preferred that the strap is comprised from reliantly deformable material. This allows the aperture of the second end to widen when passing over an enlarged head of the fastener and close once passed over to retain the second end to the fastener.

To further aid removal of the second end from the fastener, the strap may be provided with a tab that extends from the wider portion.

According to a third aspect of the invention there is provided a kit of parts for assembling a looped support, the kit comprising: a strap defining a first aperture at or towards its first end, a second aperture defined at or towards a second end; and a fastener retained in the first aperture for retaining the strap to a support.

The kit allows an installer to mount the strap to a support without first having to create and/or locate the fastener through the correct hole in the strap, thereby simplifying and quickening the installation process.

It is preferred that the fastener is retained in the first aperture by an interference fit.

It is preferred that the fastener comprises a shaft, a head, and a collar spaced from the head, and more preferred that the fastener is a pin, nail or screw.

### BRIEF DESCRIPTION OF THE DRAWINGS

The invention will now be described by way of example with reference to the following figures in which:

FIG. 1 is a side view of a kit for forming a loop hanger to brace a cable to a support, the kit comprising a strap with a nail located through one end;

FIG. 2 is a plan view of the strap;

FIG. 3 is perspective view of the strap and nail shown with the strap partly looped;

FIG. 4 is a side view of the looped hanger installed onto a support; and

FIG. 5 is a front on view showing three loop hangers used to brace cables to a support.

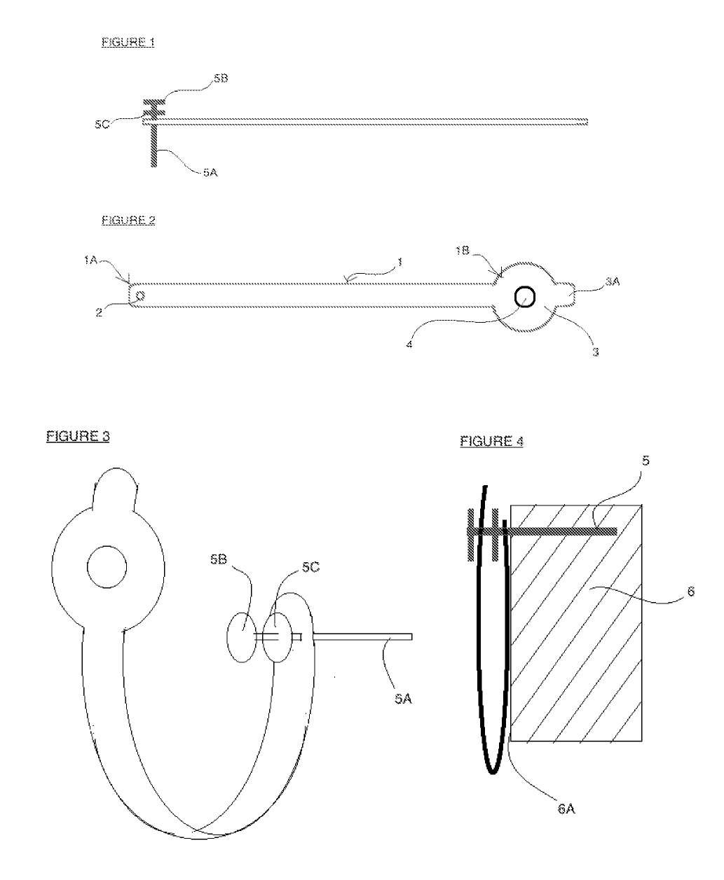

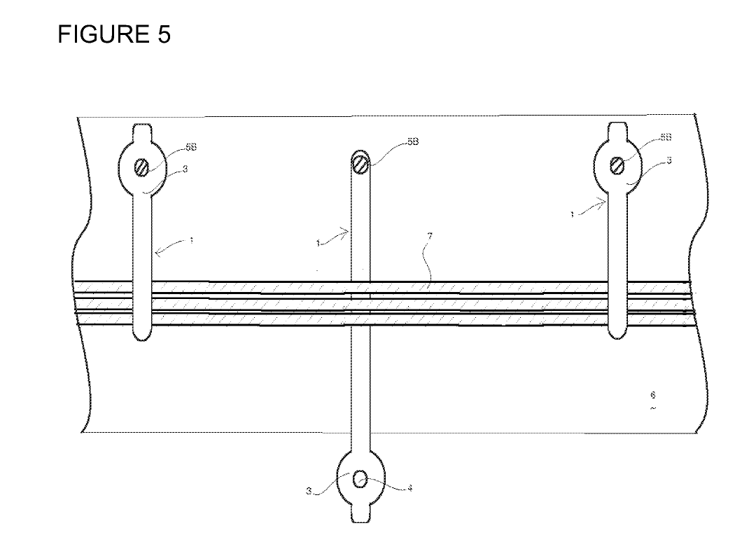

### DETAILED DESCRIPTION

There is shown a strap 1 for bracing a bundle of cables 7 to a support. The strap 1 is preferably formed as a single integral piece of resiliently flexible and deformable material e.g. a silicone. The strap 1 has a sheet like form, and may in an example construction method be formed by a stamping or cutting process on sheet material.

An aperture 2 is formed at a first end 1A of the strap 1. A second end 1B of the strap 1 is formed with a portion 3 of enlarged width and having a tab 3A. A second aperture 4 of greater diameter to the first aperture 2 is formed in the enlarged portion 3.

Preferably the strap 1 is shipped to the user as part of a kit which also includes nail 5 having a shaft 5A, a head 5B and a collar 5C that is spaced along the shaft 5A away from the head 5B.

The shaft 5A of the nail 5 is retained through aperture 2 by a friction fit. This ensures the nail 5 remains within the aperture 2 when the kit is shipped.

To brace a cable 7 or bundle of cables, the nail 5 with the strap 1 supported thereon is driven (e.g. by a hammer) into a support 6 at a point proximate to where the cable 7 is to be run, so that the first end 1A of the strap 1 is retained between the support 6 and the collar 5C leaving at least the head 5B and portion of nail 5 between head 5B and collar 5C proud of the support's 6 surface 6A and strap 1.

The second end 1B of the strap 1 is brought around the cable 7 to form a loop. The loop is closed by passing enlarged portion 3 over nail 5 so that nail head 5B passes through aperture 4. The resilient deformability of the strap 1 material allows the aperture 4 to temporarily dilate to enable the head 5B to pass through, before flexing back so that second end 1B is retained on the nail 5 between the head 5B and collar 5C.

FIG. 5 illustrates a bundle of cables 7 braced at intervals by straps 1. Should it be required to run a further cable with the bundle, the further cable 7 may either be fed through the loops of the straps 1, or alternatively and preferably, the second end 1B of each strap is pulled, with the help of tab 3A over the head 5B of the corresponding nail 5 to open the strap (FIG. 5 shows this done to the middle strap), whereupon the extra cable(s) can be laid before the loops re-closed to brace the enlarged bundle in the manner as before described.

The enlarged portion 3 makes it easier to grasp the second end of the strap so that it can be pushed over or pulled off the nail head 5B.

In an alternative embodiment, an alternative type of fastener may be used such as for example a screw or pin. Notwithstanding, it is still preferred that the fastener has a head and collar.

Although the hanger has been described in relation to bracing cable, the hanger may be used for bracing or hanging a variety of objects of different shapes and sizes from a support.

The illustrations of examples described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Additionally, unless otherwise specifically expressed or clearly understood from the context of use, a term as used herein describes the singular or the plural of that term.

The terms “a” or “an”, as used herein, are defined as one or more than one. The term “plurality”, as used herein, is defined as two or more than two. The term “another”, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Although specific embodiments have been illustrated and described herein, it should be appreciated that any arrangement calculated to achieve the same purpose may be substituted for the specific embodiments shown. The examples herein are intended to cover any and all adaptations or variations of various embodiments. Combinations of the above embodiments, and other embodiments not specifically described herein, are contemplated herein.

The Abstract is provided with the understanding that it is not intended be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

The corresponding structures, materials, acts, and equivalents of all means or step plus function elements in the claims below are intended to include any structure, material, or act for performing the function in combination with other claimed elements as specifically claimed. The description herein has been presented for purposes of illustration and description, but is not intended to be exhaustive or limited to the examples in the form disclosed. Many modifications and variations will be apparent to those of ordinary skill in the art without departing from the scope of the examples presented or claimed. The disclosed embodiments were chosen and described in order to explain the principles of the embodiments and the practical application, and to enable others of ordinary skill in the art to understand the various embodiments with various modifications as are suited to the particular use contemplated. It is intended that the appended claims below cover any and all such applications, modifications, and variations within the scope of the embodiments.

1. A method of bracing a length of cable comprising:
fastening a strap at or about its first end to a support by driving a fastener passed through the strap into the support leaving an end of the fastener proud of the strap; and
passing a second end of the strap around the cable and over the proud end of the fastener to form a loop, and/or feeding the cable through the loop once formed.

2. A method according to claim 1 wherein the fastener comprises a shaft, a head and a collar spaced from the head, and the method comprising driving the fastener into the support to retain the strap between the support and the collar leaving the head proud of the strap; and passing the second end of the strap over the head of the fastener.

3. A method according to claim 2 where the second end is passed over the fastener so as to sit between the head and collar of the fastener.

4. A method according to claim 1, for bracing a further cable with a first braced cable, comprising the further step of releasing the second end of the strap from the fastener to open the loop; running the cable alongside the first cable; and then passing a second end of the strap around the cables and over the proud end of the fastener to reform the loop.

5. A strap suitable for use as a looped hanger, the strap having a first aperture at or towards a first end through which, when in use, a fastener passes to retain the strap to a support; the strap also comprising a wider portion at or towards a second end of the strap; a further aperture defined in the wider portion for retaining the second end of the strap, when looped, over the fastener; and wherein a portion of the strap that defines the first aperture is comprised from a sheet-like material.

6. A strap according to claim 5 comprising a tab that extends from the wider portion to facilitate removal of the second end from the fixing.

7. A strap according to claim 6 comprised from a single integral piece of flexible synthetic plastic material.

8. A strap according to claim 5, wherein a portion of the strap that defines the first aperture is comprised from a resiliently deformable sheet material.

9. A kit of parts for assembling a looped support, the kit comprising:
a strap defining a first aperture at or towards a first end, a second aperture defined at or towards a second end; and a fastener, retained in the first aperture, for retaining the strap to a support.

10. A kit according to claim 9, wherein the fastener is retained in the first aperture by a friction fit.

11. A kit according to claim 9, wherein the fastener comprises a shaft, a head, and a collar spaced from the head.

12. A kit according to claim 9, wherein the fastener is a pin, nail or screw.

13. A method of bracing a length of cable comprising:
fastening a strap at or about its first end to a support by driving a fastener passed through the strap into the support leaving an end of the fastener proud of the strap; and
passing a second end of the strap around the cable and over the proud end of the fastener to form a loop.
